(19) United States
(12) Patent Application Publication
(10) Pub. No.: US 2009/0119253 A1
(43) Pub. Date: May 7, 2009

(54) Introduced in Website's Price and other Market Search System

(76) Inventors: DAVI PIALA DOS SANTOS, Curitiba (BR); GASTAO JUNIOR QUATORZE VOLTAS, Curitiba (BR); PRISCILA APARECIDA QUATORZE VOLTAS, Curitiba (BR)

Correspondence Address: FURR LAW FIRM, 2622 DEBOLT ROAD, UTICA, OH, 43080, US

(21) Appl. No.: 11/935,393

(22) Filed: Nov. 5, 2007

(51) Int. Cl. G06F 7/06; G06F 17/30

(52) U.S. Cl. 707/3; 707/E17.108

(57) ABSTRACT

This patent presentation refers to an innovator website's price and other market search system that has the subject matter to allow search prices between supermarkets, pharmacies, gas station and others activities. Moreover it's possible to get details about products, suppliers, qualities, guarantees and prices for consumption ends, characterized by software (01).

### BACKGROUND OF THE INVENTION

The internet is a dynamic tool, and its users always seek new technologies and easier ways to do the same thing or new ways to do other ones that were not possible before. The search systems headed by Google Inc., follow the same principles.

The internet user who wants to produce a shop list or comparisons between supermarkets, gas stations, pharmacies and other by your neighborhood, doesn't get help on traditional methods.

Several times, the small commercial establishments don't have financial conditions to develop a website and appear in those traditional search systems. In this way, the company loses a great parcel of market for not being inserted digitally.

### BRIEF SUMMARY OF THE INVENTION

This patent presentation refers to an innovator website's search system, which subject matter is to allow the price and others market searches to the internet user, such as: supermarkets, pharmacies, gas stations and others activities.

In these searches, the user will have, among others tools, the daily offers, price seek, price comparisons, list of products, analysis of suppliers. This website will allow huge consultation options by the internet user. He will get all about the details of the products, the supplier, the qualities, guarantees and prices for consumption ends.

### BRIEF DESCRIPTION OF THE SEVERAL VIEWS OF DRAWING

Without restricting the full scope of this invention, the preferred form of this invention is illustrated in the following drawings:

FIG. 1 shows the technical specifications and how it will be the website use to search prices and others market researches (1); FIG. 1 is a flow chart showing the available functions of “www.mysite.com”.

FIG. 2 is a flow chart showing the path from “Customer's Login” to “Customer's Profile”, and “Company's Login” to “Company's Profile”.

FIG. 3 is a flow chart showing how “Customer's Register” works.

FIG. 4 is a flow chart showing how “Company Register” works.

FIG. 5 is a flow chart showing the process of the “Prices Search”.

FIG. 6 is a flow chart showing the process of “Best Price”.

FIG. 7 is a flow chart for “About Us” and “Publicity”.

FIG. 8 is a flow chart showing the function of the “Register List”.

FIG. 9 is a flow chart showing the functions of “Customer's Profile”.

FIG. 10 is a flow chart showing the path from “Offers Warning” to “Customer's mailbox”.

FIG. 11 is a flow chart showing the functions of “Company's Profile”.

FIG. 12 is a flow chart showing the possible paths from “Products List”.

FIG. 13 is a flow chart showing the possible paths from “Change company's data”.

FIG. 14 is a flow chart showing the possible paths from “Offers Warning”.

FIG. 15 is a flow chart showing the possible paths from “How am I?”.

FIG. 16 is a flow chart showing the possible paths from “Prices Report”.

FIG. 17 is a flow chart showing the possible paths from “My Offers”.

FIG. 18 is a flow chart showing the possible paths from “Medicine Lists Registration” under “Lists Register.”

FIG. 19 is a flow chart showing the possible paths from “List of Supermarket” under “Lists Register.”

FIG. 20 is a flow chart showing the function of “My Data”.

FIG. 21 is a flow chart showing the possible paths from “My List”.

FIG. 22 is a flow chart showing the possible paths from “My Ways”.

FIG. 23 is a flow chart showing the possible paths from “Way of the Price”.

FIG. 24 is a flow chart showing the possible paths from “Change/Include Products and Prices”.

FIG. 25 is a flow chart showing the possible paths from “.Alteration of the Price”.

FIG. 26 is a flow chart showing the process of “Temporary” to get to update the prices.

FIG. 27 is a flow chart showing the process of “Temporary” to get to the Customer's E-mail.

FIG. 28 is a flow chart showing the possible paths from “Alteration of Lists”.

FIG. 29 is a flow chart showing the “Lists of the Products” option to “File of products that I do not possess.”

FIG. 30 is a flow chart showing the “Lists of the Products” option to “File of my products and prices”.

FIG. 31 is a flow chart showing the function of “Edition of Way”.

### DETAILED DESCRIPTION OF THE INVENTION

The data processing system 1 for the current invention embodiments includes computer processing means for processing data, storage means for storing data on a storage medium, and communication means for transferring data in a secure environment.

The system 1 can be set up to be run on a computing device which can comprise a CPU, CPU Main Memory and a portion of main memory where the program resides and executes. A printer can also be included. Any general purpose computer with an appropriate amount of storage space is suitable for this purpose. Computer Devices like this are well known in the art and is not pertinent to the invention.

The computer device can be connected to other computer devices through a communication interface such as the Internet, a wide area network (WAN), internetwork, telephone network or a private Value Added Network (VAN).

The storage and databases for the system may be implemented by a single data base structure at an appropriate site, or by a distributed data base structure that is distributed across an intra or an Internet network.

The files and file components discussed herein may be paper files, but in a preferred embodiment comprise data structures with electronic data. The setting up of the files and file structure is commonly known in the art and is not disclosed here.

The information basis is provided by the commercial establishment owners, like supermarkets, pharmacies and gas stations, about addresses, surroundings, company data (commercial contract, e-mail, name, functioning schedule) and, obviously, their products and offers.

The customers will be registered by country, state, city, quarter and e-mail, and will inform if want receive surrounding offers and will register their shop lists. With their lists registered, which can be scheduled on the system that will send the best shop option, comparing where the customer is set up.

These are the tools which specify how the internet user 10 will do the search:

Daily Offers:

Shows an offer list by region, selected by the customer. There are filter options for each activity (Pharmacies, Supermarket, Gas Stations).

Offers Warning:

The system 1 sends an e-mail to the customer with the establishment offers from his region and profile. The customer can define the profile and which are the activities that will be warned by e-mail.

Prices Search:

The system 1 allows the prices search by customer. These prices will be updated directly by the commercial establishment owners. The search will request only the name of the product and will be shown in list indicating the best prices of the region.

Shop List:

The registered customers can select the product in a complete product list to do their own. On this list, the customer can define which days the list will be send for his e-mail indicating which commercial establishment in the region is the best shop option.

Report of Prices:

The system 1 compares prices of the company in relation to the region market with its respective rank. It's excellent to those companies to know if their prices are higher or lower.

Price Way:

For example, the customer lives in “A” quarter and works in “B” quarter. This tool shows which gas station has the best fuel price in his way. The way keeps recorded and will be sending by e-mail to the customer as the desired day, weekly or monthly.

Best Price:

In this option, the customer types the name of product and its exhibition will be instantaneous with all information about the company and which of them has the best price, only considering the customer address.

Product List:

An option to the owners verifies which products are registered. They can also generate a product list available and unavailable in their company.

Products and Prices Auto-Update:

For those companies which have a database, it will be connected to the search system by an interface. The prices and the products will be auto-updated daily. This interface is done by file transmission.

How am I?

It's interesting for all companies scale because its option classifies the companies by the generation of lists amount how they were been the best shop option.

How it works:

To the market:

A customer lives in the South direction can do a shop list and get the best option of a company in his surroundings. This list is registered in the system by itself. The system sends an e-mail on the fixed days defined by the client with his shop list and the best options. If the customer will add or remove some products, it can be done in real time and the new account will be recalculated immediately. If the best choice of shopping change the customer will be advised where is the best price. It has the option of consulting directly in this website in order to confirm the best price, or others information too.

To the gas-stations:

The customer registers which is the fuel he needs, the System shows him, according the local and fuels he uses, where is the best option in the surroundings. These prices will be sent by e-mail or seen in the website. In the option for email the regularity of the sending of the e-mail with the prices can be defined which.

To the pharmacies:

The customer will register a drug-list in the databases and he will get the best option of shopping according his region. There is an option of registering needed drugs.

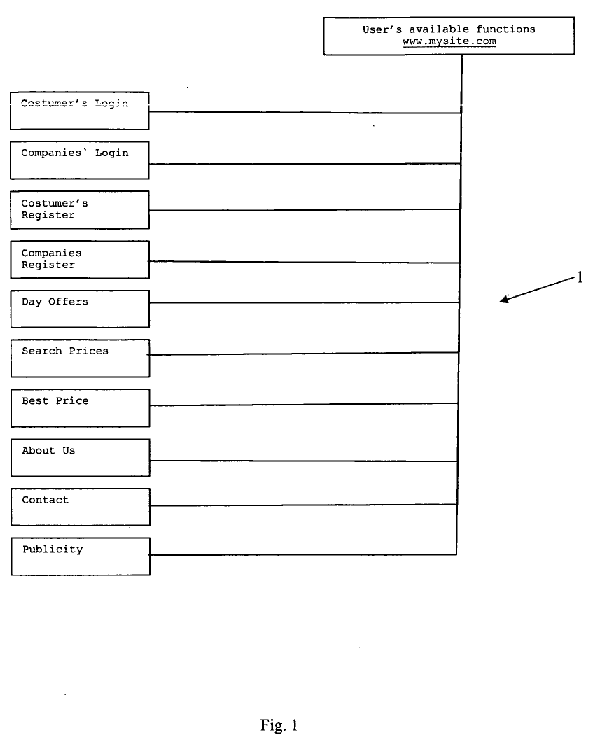

FIG. 1 shows the available functions of www.mysite.com. These functions include, “Customer's Login”, “Company's Login”, “Customer's Register”, “Company's Register”, “Day Offers”, “Search Prices”, “Best Prices”, “About Us”, “Contact”, and “Publicity”.

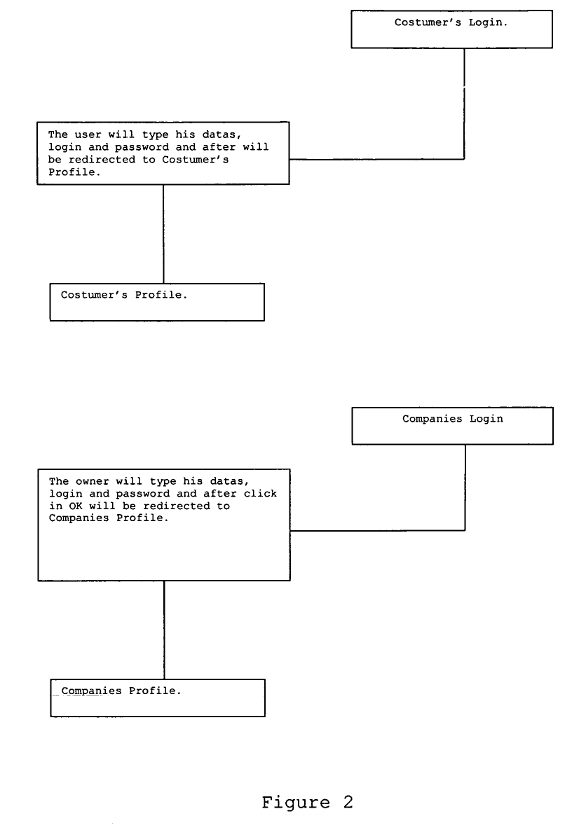

FIG. 2 shows the processes of “Customer's Login” to “Customer's Profile” and of “Company's Login” to “Company's Profile”. From “Customer's Login, the user will type his data, login and password and after will be redirected to “Customer's Profile”. From “Company's Login” the owner will type his data, login and password, and after clicking OK will be redirected to “Company's Profile”.

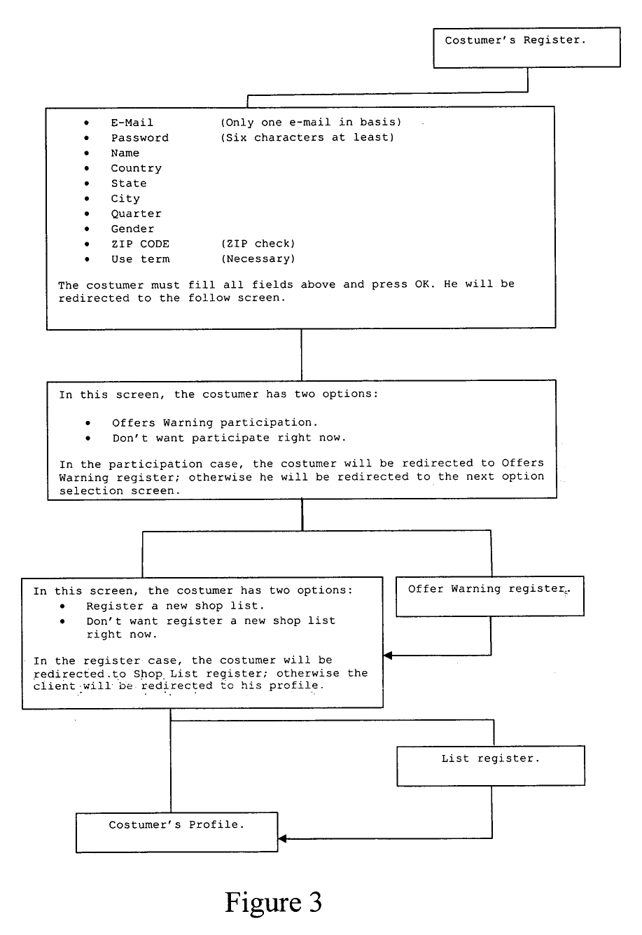

FIG. 3 is a flow chart showing how “Customer's Register” works. “Customer's Register” leads to the user entering e-mail, password (at least six characters”, name, country, state, city, quarter, gender, zip code, and use term. After pressing OK, the user will be redirected to a screen with two options: “Offers Warning participation” and “Don't want to participate right now.” The “Don't want to participate right now” option redirects the user to the next option screen. The “Offers Warning participation” option will redirect the user to the “Offer Warning register” screen and then to the next option screen. The next option screen gives the options to “Register a new shop list” or “Don't want to register a new shop list right now.” In the register case, the customer is redirected to Shop List register and then his profile; otherwise the client will be redirected straight to his profile.

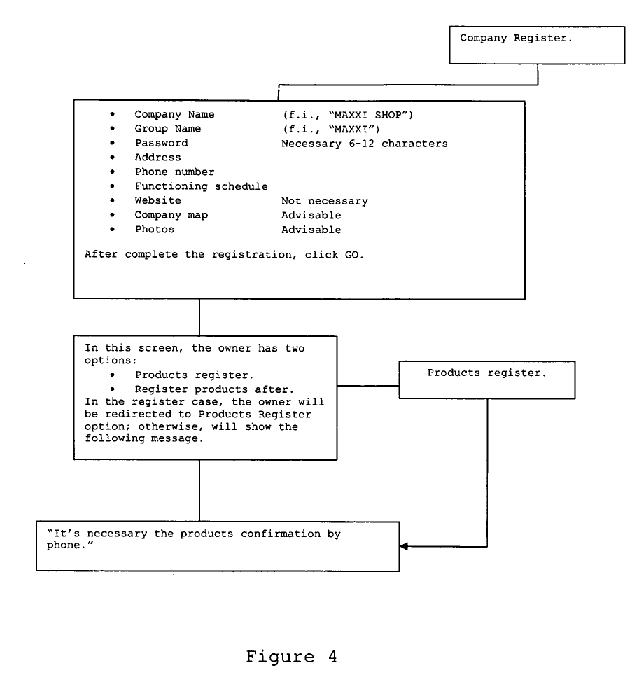

FIG. 4 is a flow chart showing how “Company Register” works. From “Company Register” the user enters company name, group name, password (6-12 characters), address, phone number, functioning schedule, website (not necessary), company map, and photos. After clicking GO, the owner will be taken to the next option screen, with the options “Product register” and “Register products after.” In the register case, the owner will be redirected to “Products Register” option and then to the message, “It's necessary the products confirmation by phone.” Otherwise, the owner will just be shown the message.

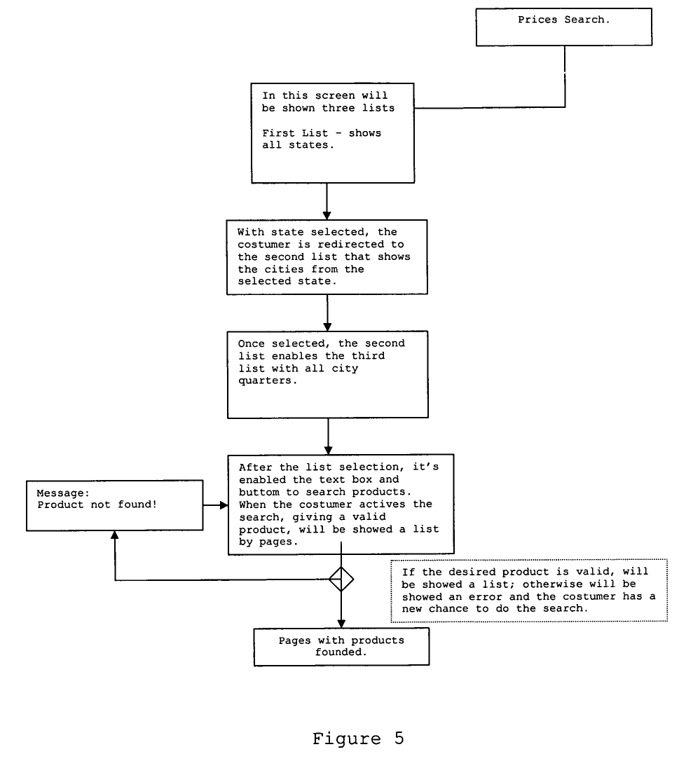

FIG. 5 is a flow chart showing the process of the “Prices Search”. The screen will show three lists. The first list shows all states. With the state being selected, the customer is redirected to the second list that shows the cities from the selected state. The second list then enables the third list with all city quarters. After the list selection, the text box and button to search products are enabled. The customer will be shown pages with products found, or given the message, “Product not found!” and then taken back to the search option.

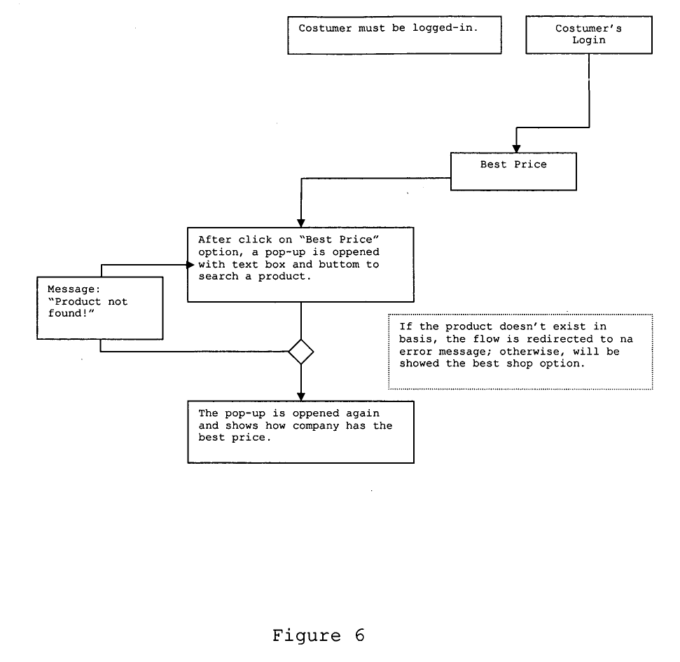

FIG. 6 is a flow chart showing the process of “Best Price”. After clicking on “Best Price,” a pop-up window is opened with a text box and button to search for a product. Then a pop-up is opened again, showing which company has the best price, or will be shown the message, “Product not found!” and then is taken back to the search option.

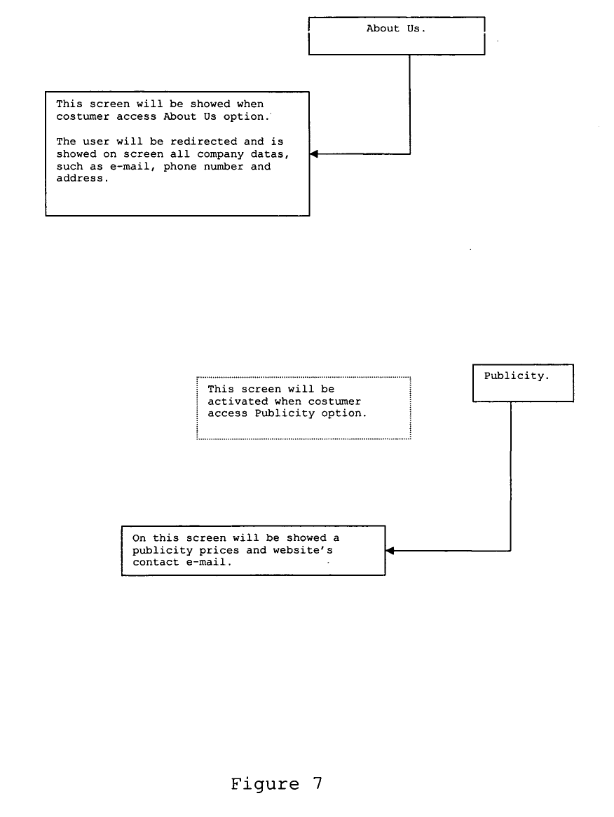

FIG. 7 is a flow chart for “About Us” and “Publicity”. The “About Us” option redirects the users to a screen that shows the company data, such as e-mail, phone number, and address.—The “Publicity” option shows publicity prices and the website's contact e-mail.

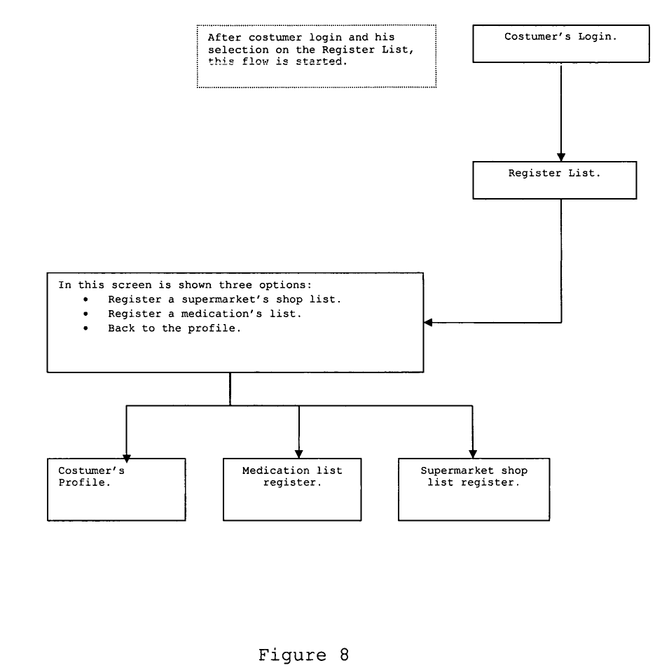

FIG. 8 is a flow chart showing the function of the “Register List”. A screen is shown with three options: “Register a supermarket's shop list,” “Register a medication's list,” and “Back to the profile.” These options take the user to “Customer's Profile,” “Medication list register,” or “Supermarket shop list register.”

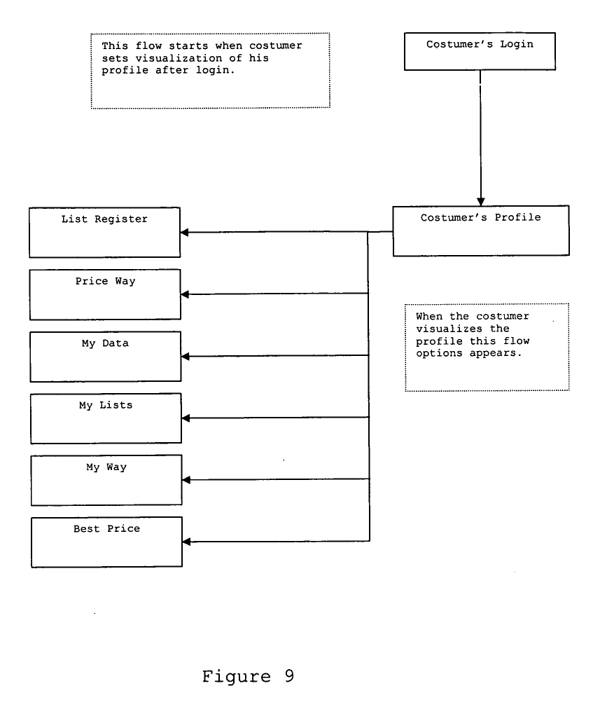

FIG. 9 is a flow chart showing the functions of “Customer's Profile”. The options are: “List Register,” “Price Way,” “My Data,” “My Lists,” “My Way,” and “Best Price.”

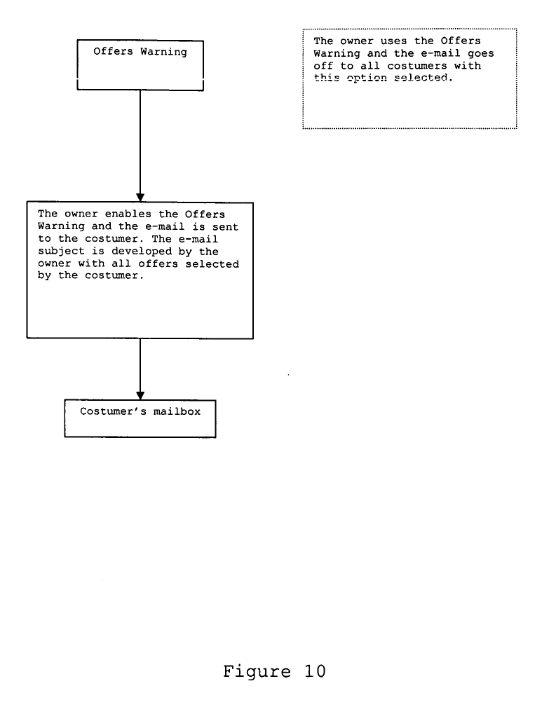

FIG. 10 is a flow chart showing the path from “Offers Warning” to “Customer's mailbox”. The owner enables the Offers Warning and an e-mail is sent to the customer with all the offers selected by the customer.

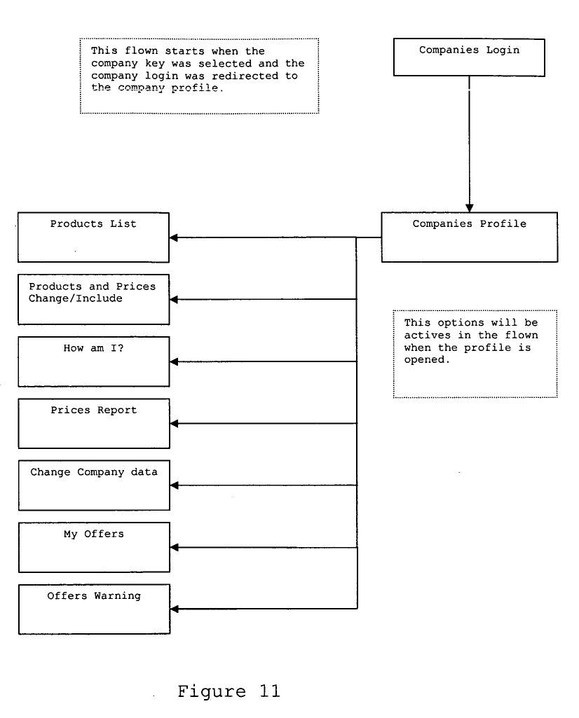

FIG. 11 is a flow chart showing the functions of “Company's Profile”. The options are: “Products List,” “Products and Prices Change/Include,” “How am I?,” “Prices Report,” “Change Company Data,” “My Offers,” and “Offers Warning.”

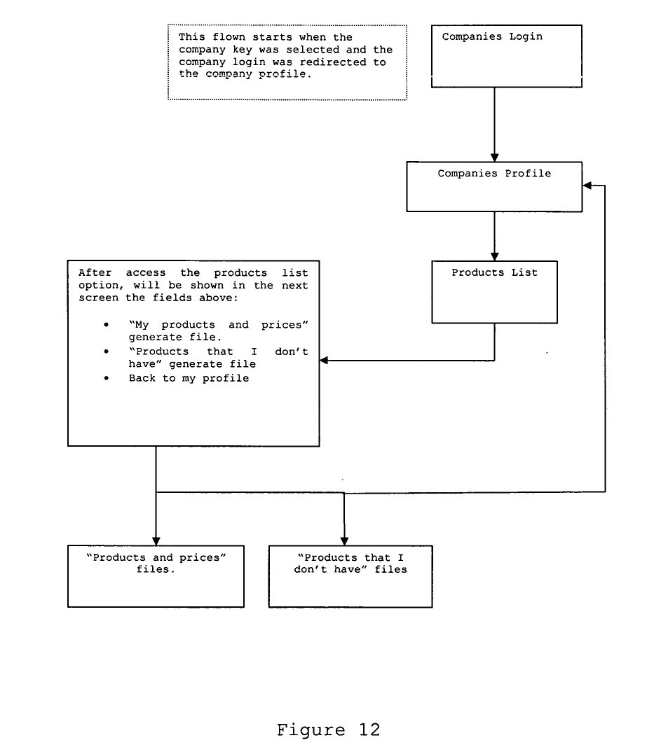

FIG. 12 is a flow chart showing the possible paths from “Products List”. After access to the products list option, the user will be shown a screen with the options: “My products and prices,” “Products that I don't have,” and “Back to my profile.” The user will then be taken to “Products and Prices” files, “Products that I don't have” files, or back to Company's Profile, depending on the option selected.

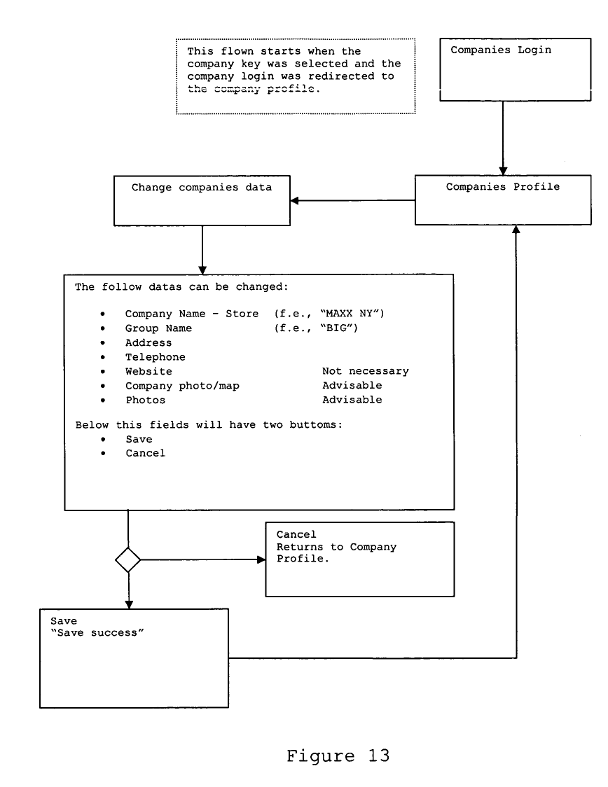

FIG. 13 is a flow chart showing the possible paths from “Change company's data”. The following data can be changed: company name, group name, address, telephone, website, and company photo/map. The user then can chose to Save or Cancel. Saving shows the message “Save successful” and canceling returns the user to “Company Profile.”

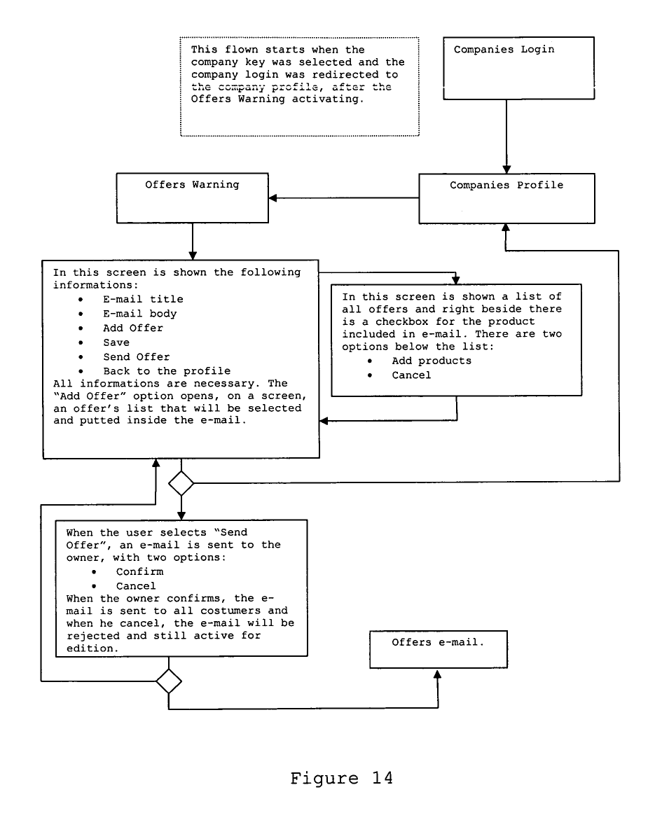

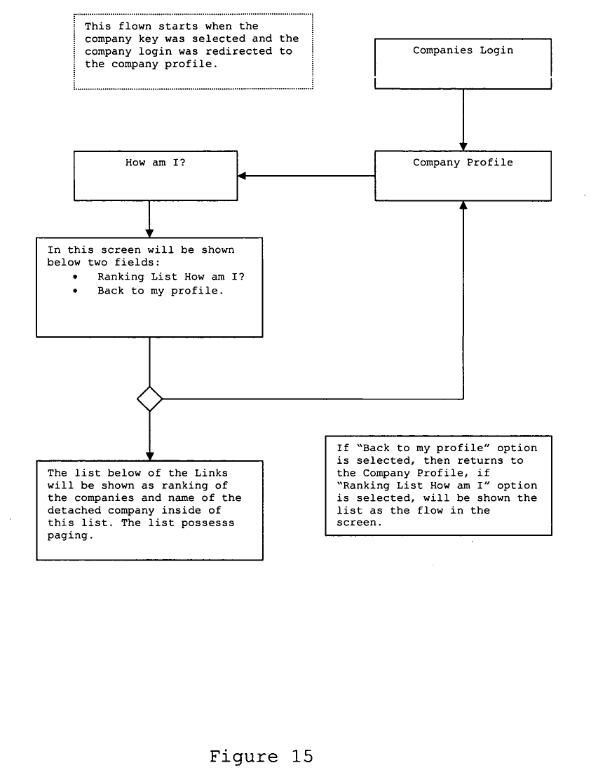

FIG. 14 is a flow chart showing the possible paths from “Offers Warning”. A screen with e-mail title, e-mail body, add offer, save, send offer, and back to the profile will be shown. Back to profile returns to user to “Company's Profile,” and send offer sends an email to the owner with the options to confirm or cancel. Canceling returns the user to the first option screen and confirming sends the offer e-mail.

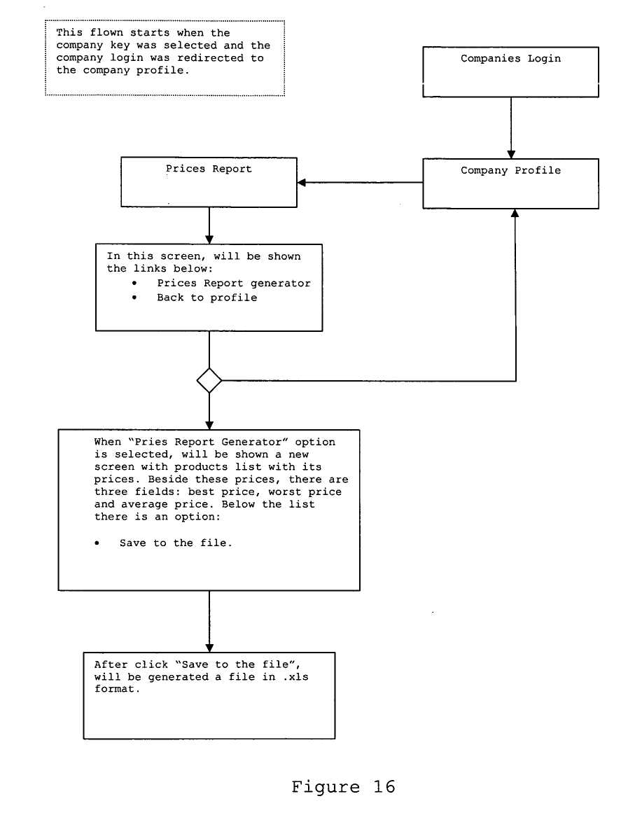

FIG. 15 is a flow chart showing the possible paths from “How am I?”. A screen with two options is shown. “Ranking List” gives a list ranking the companies. “Back to my profile” returns the user to “Company Profile.”

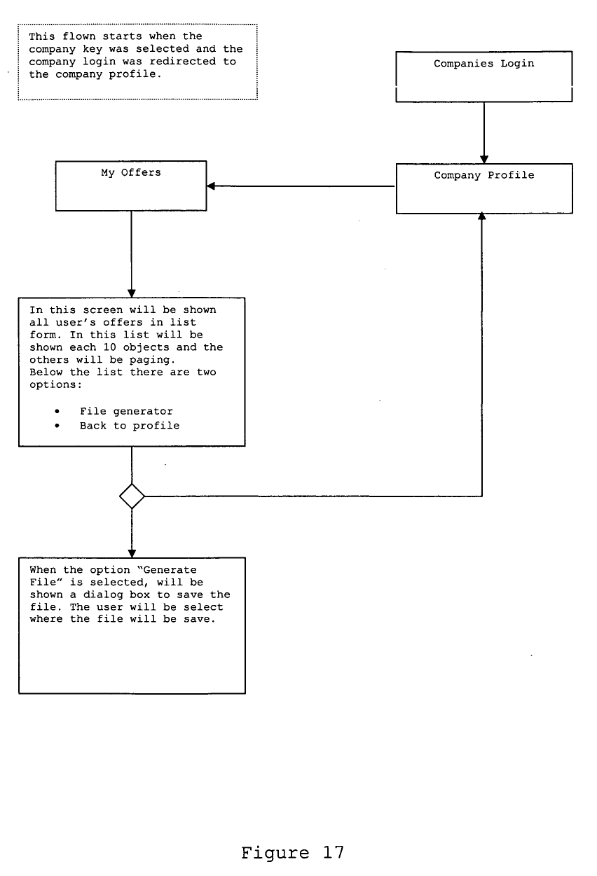

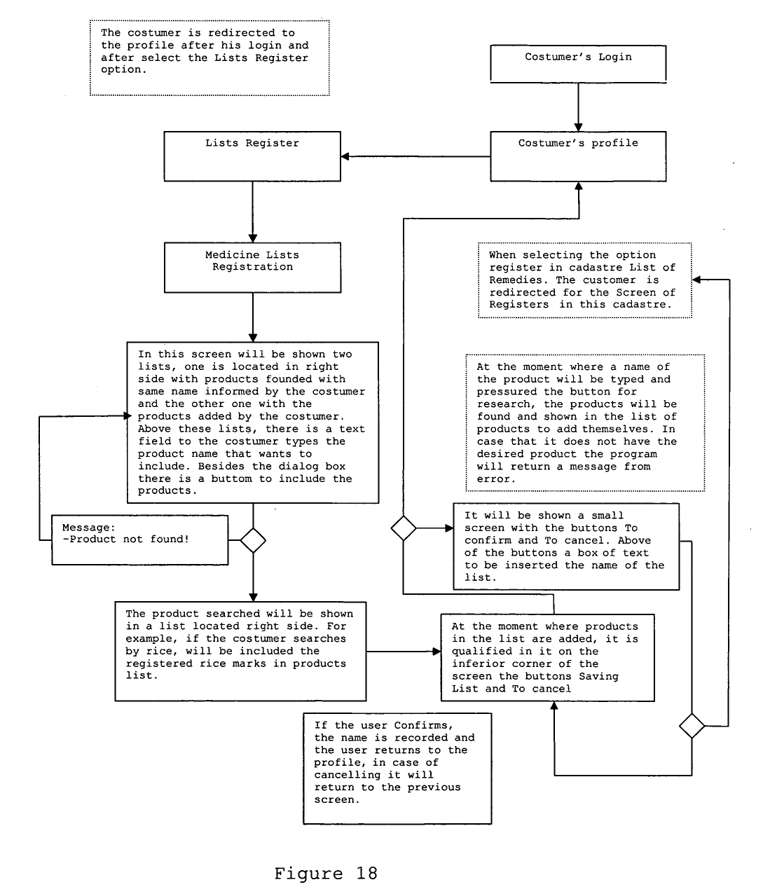

FIG. 16 is a flow chart showing the possible paths from “Prices Report”. The screen gives the options to go to the “Prices Report generator” or “Back to profile.” “Back to profile” returns the user to “Company Profile.” When the “Prices Report Generator” option is selected, a new screen with products listed with their prices will be shown. This includes best price, worst price, and average price. Clicking “Save to the file” will generate a file in .xls format.

FIG. 17 is a flow chart showing the possible paths from “My Offers”. All offers will be listed. Below the list are the options “File Generator” and “Back to Profile.” “File Generator” shows a dialog box to save the file. “Back to Profile” returns the user to the “Company Profile.”

FIG. 18 is a flow chart showing the possible paths from “Medicine Lists Registration” under “Lists Register.” The user enters the product name to be included. The product search will be shown in a list located on the right side or returns the message, “Product not found!” and returns the user to the search field. If it is found, the user can save the list or cancel. Canceling returns the user to “Customer Profile” and saving redirects the customer to the “Screen of Registers.”

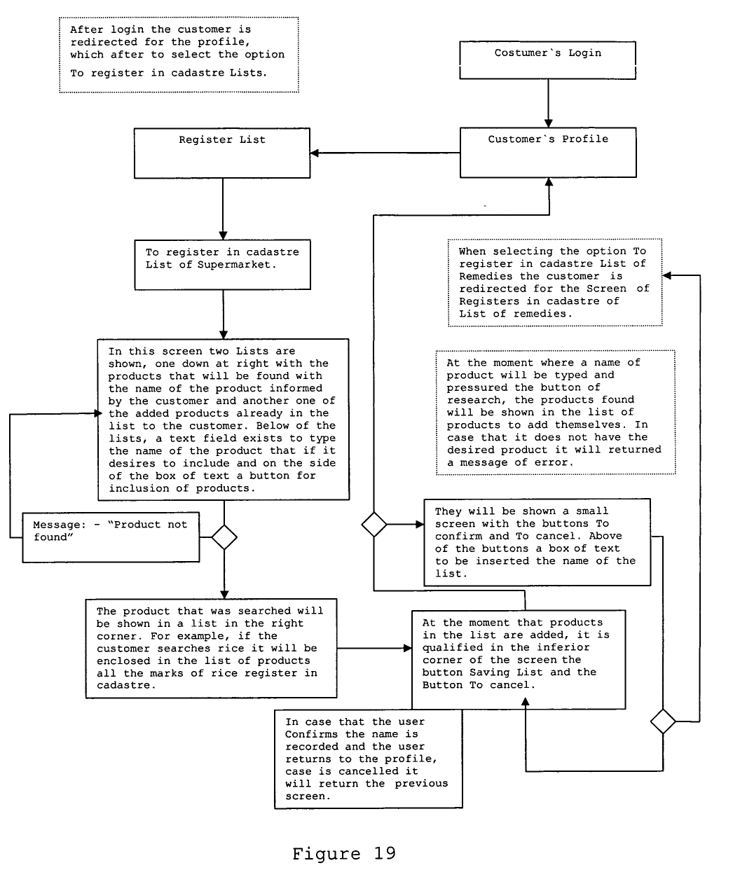

FIG. 19 is a flow chart showing the possible paths from “List of Supermarket” under “Lists Register.” The user enters the product name to be included. The product search will be shown in a list located on the right side or returns the message, “Product not found!” and returns the user to the search field. If it is found, the user can save the list or cancel. Canceling returns the user to “Customer Profile” and saving redirects the customer to the “Screen of Registers.”

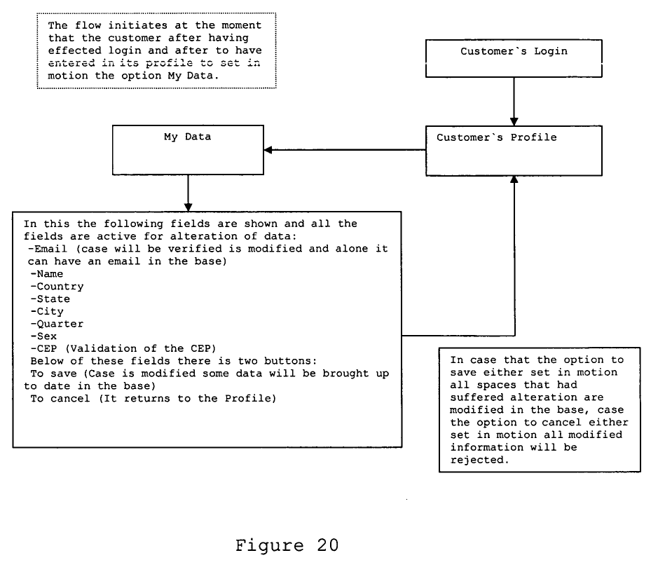

FIG. 20 is a flow chart showing the function of “My Data”. A screen displays the following information that is able to be altered: e-mail, name, country, state, city, quarter, sex, and CEP. The user then can either save or cancel. Save updates the data in the database and canceling returns to the profile.

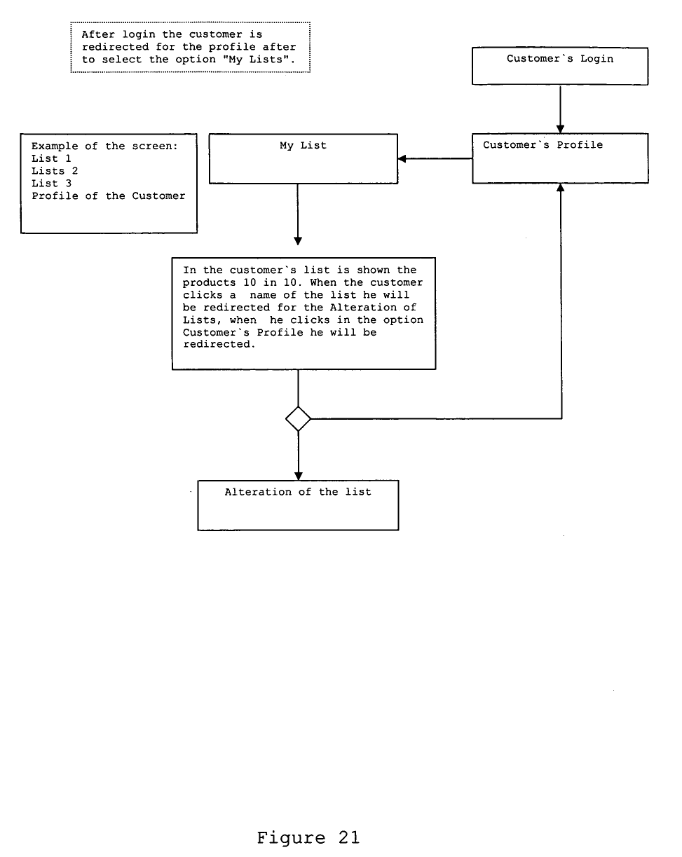

FIG. 21 is a flow chart showing the possible paths from “My List”. When the customer's list is shown, he/she can click a name in the list and be redirected to “Alteration of the list” or click “Customer's Profile” and be returned to the profile.

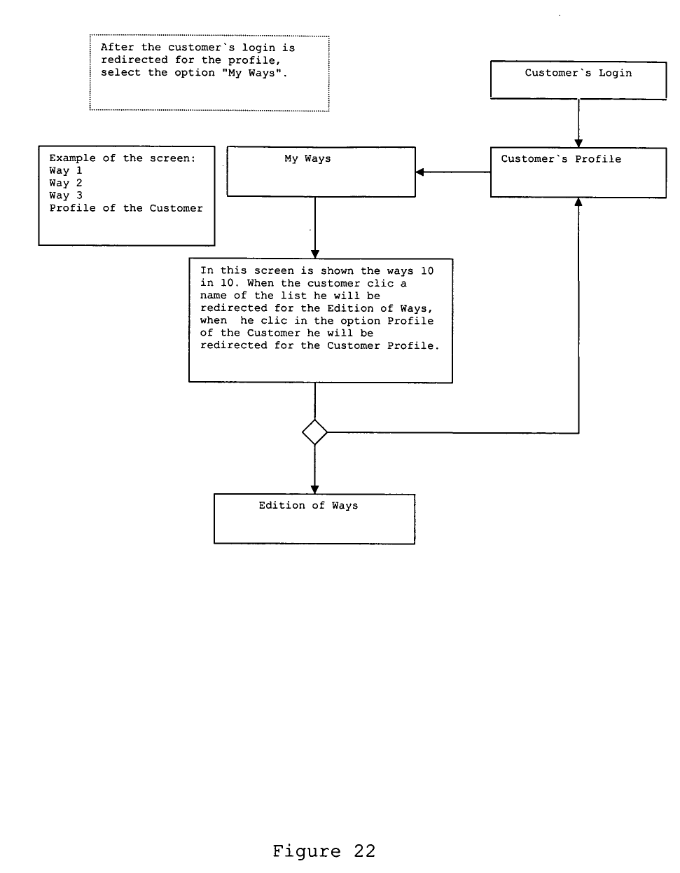

FIG. 22 is a flow chart showing the possible paths from “My Ways”. The customer can click a name in the list and be redirected to the “Edition of Ways” or click the “Customer Profile” option and be returned to the profile.

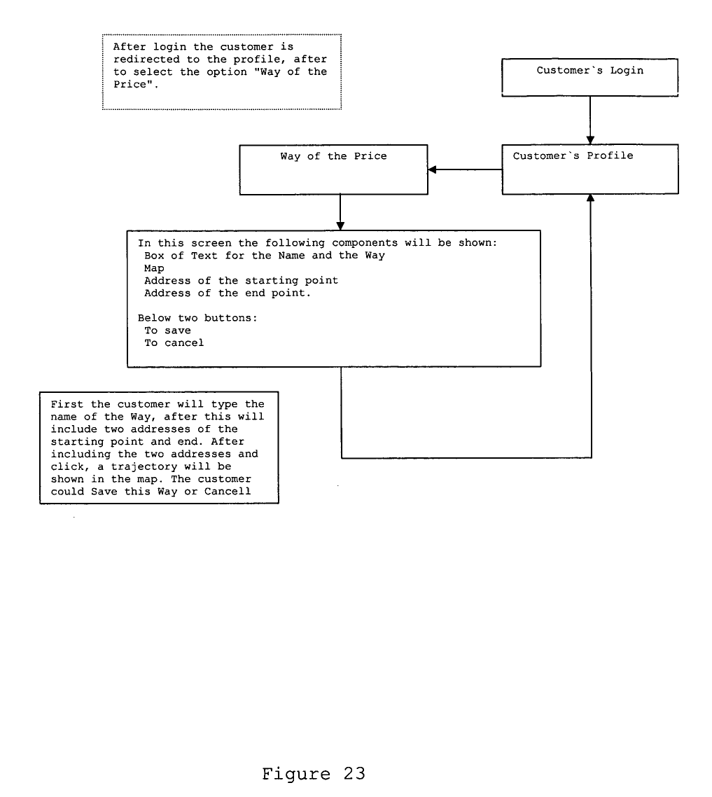

FIG. 23 is a flow chart showing the possible paths from “Way of the Price”. A screen with the following components will be shown: box of text for the name and the way, map, address of the starting point, and address of the end point. There will then be the option to save or to cancel.

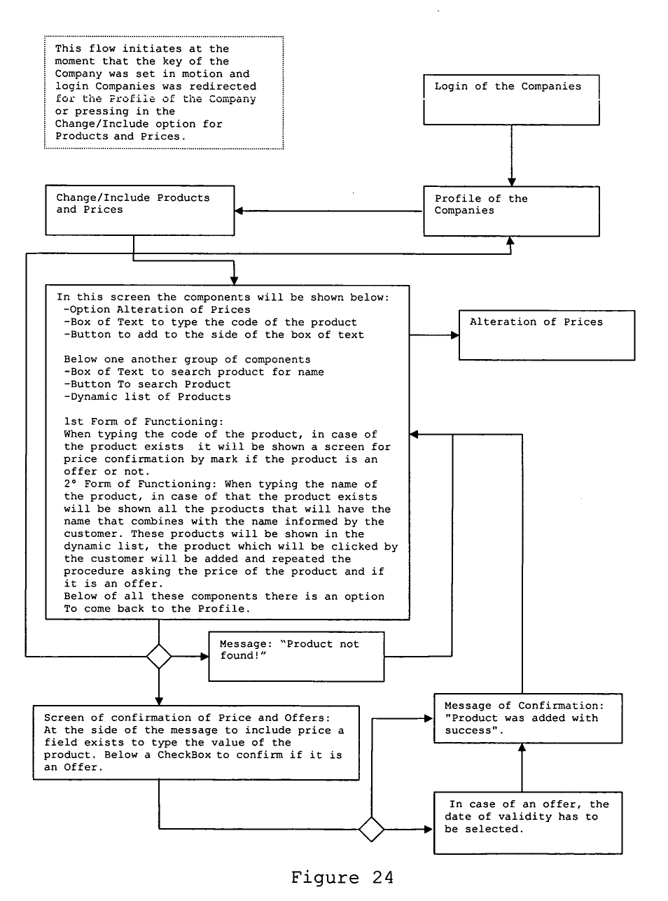

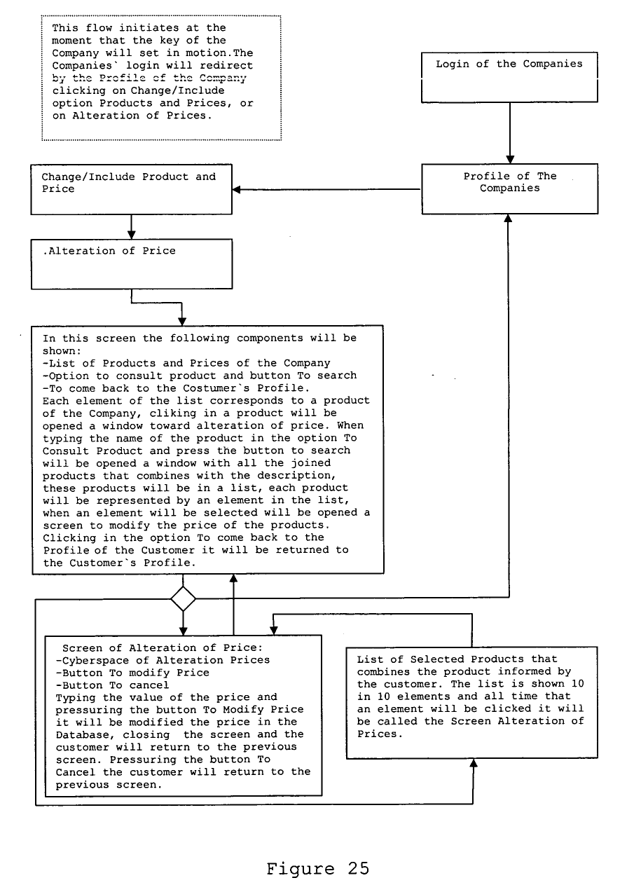

FIG. 24 is a flow chart showing the possible paths from “Change/Include Products and Prices”. A screen with the options to alter prices, a text box to type the code of the product, and a button to add to the side of the text box is shown. Below those is another group of components: a text box to search for product name, a button to search for the product, and a dynamic list of products. There is also an option to return to the profile, which returns the user to “Company Profile.” If the product isn't found, the message, “Product not found!” will be shown and the user will be returned to the option screen. If it is found, a screen confirming the price and offers is shown. The user then can confirm if it is an offer, and then is given the message “Product was added with success,” returning the user to the option screen.

FIG. 25 is a flow chart showing the possible paths from “.Alteration of the Price”. The screen shows a list of products and prices of the company, an option to consult product and a button to search, and an option to return to “Company Profile.” The user is then either returned to “Company Profile,” taken to the screen of alteration of price, or shown a list of selected products. The screen of alteration of price allows the user to modify the price or to cancel, which then returns to the previous screen or closes the screen. The list of selected products combines the product information from the customer. Clicking an item in the list takes the user to the screen of alteration of price.

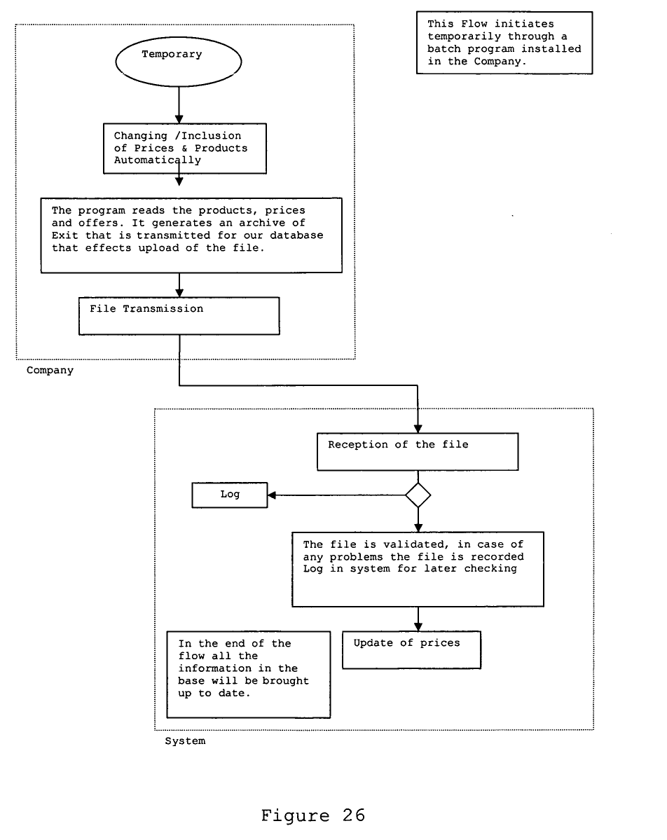

FIG. 26 is a flow chart showing the process of “Temporary” to get to update the prices. The program reads the products, prices and offers. It generates an archive and the file is transmitted to the batch program which receives the file. The file is then logged or validated. If validated, the prices are updated.

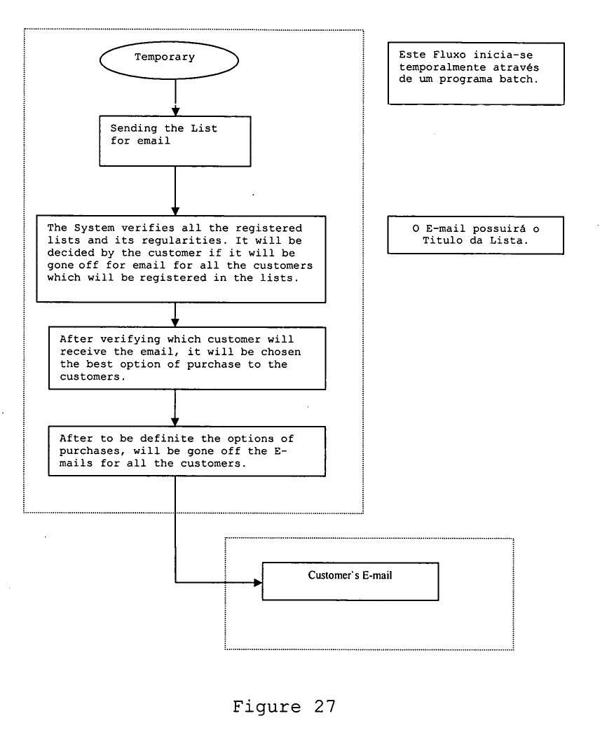

FIG. 27 is a flow chart showing the process of “Temporary” to get to the Customer's E-mail. The system verifies all the registered lists. It is decided by the customer if it will go off through e-mail for all the customers. After verifying which customer will receive the email, the best option with be chosen. It will then be sent to the Customer's e-mail.

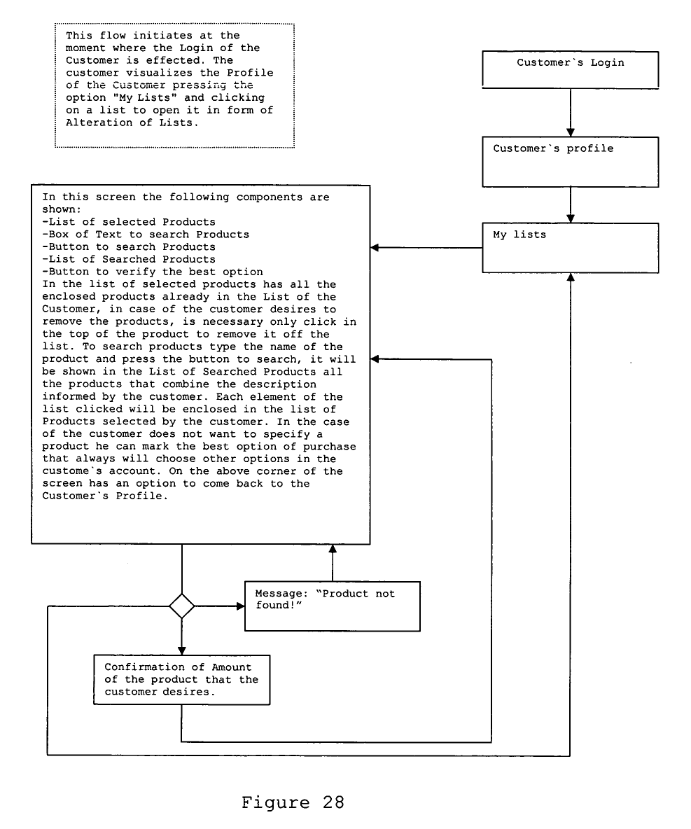

FIG. 28 is a flow chart showing the possible paths from “Alteration of Lists”. The screen shows a list of selected products, a text box to search products, button to search products, list of searched products, and a button to verify the best option. The amount of the product the customer desires will be confirmed or the message “Product not found!” will be displayed. The user is then returned to the option screen.

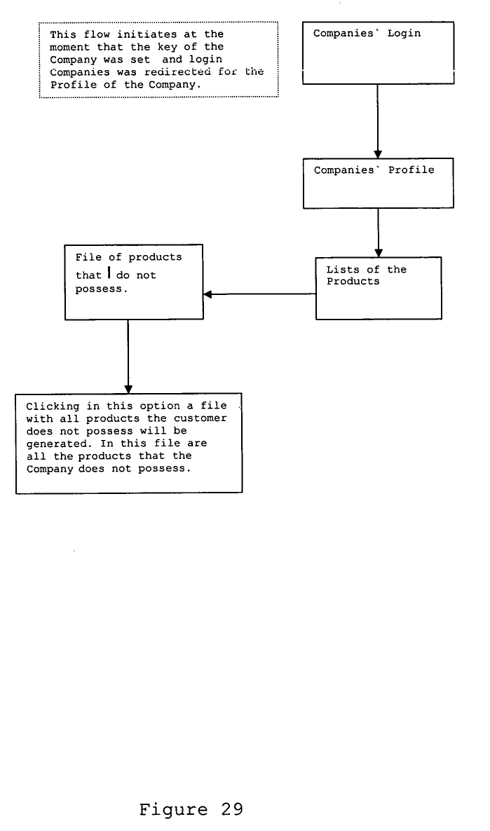

FIG. 29 is a flow chart showing the “Lists of the Products” option to “File of products that I do not possess.” Clicking on this option generates a file with all products the customer does not possess.

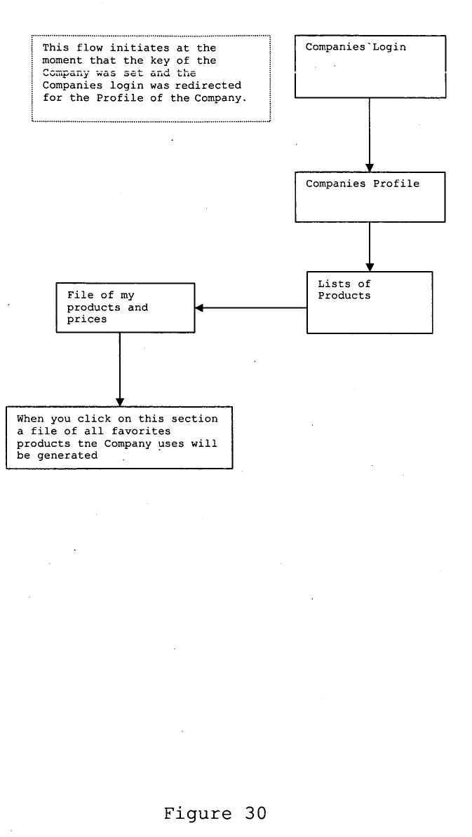

FIG. 30 is a flow chart showing the “Lists of the Products” option to “File of my products and prices”. When the user clicks this option, a file of all the favorite products the company uses will be generated.

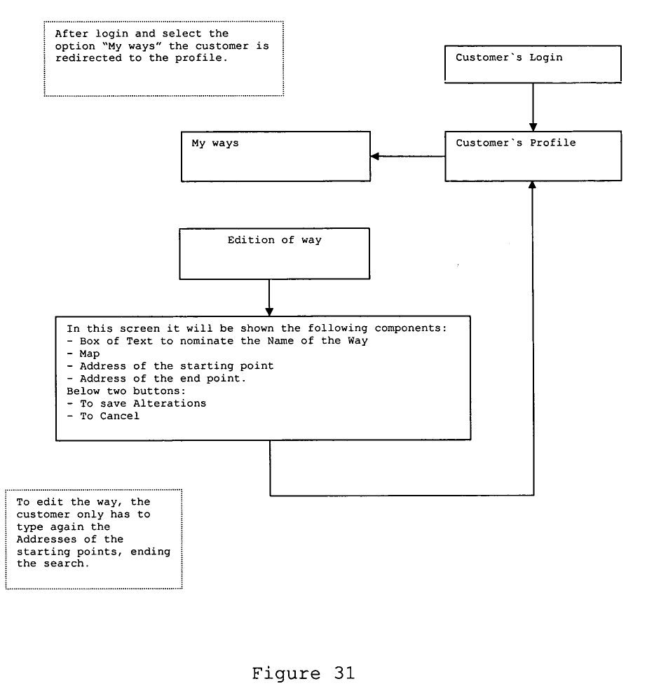

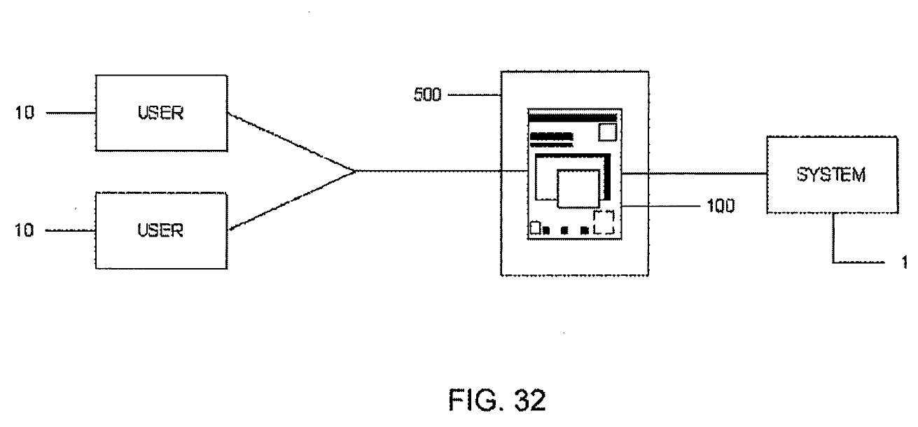

FIG. 31 is a flow chart showing the function of “Edition of Way”. The screen shows a text box to nominate the “Name of the Way”, a map, address of the starting point, address of the end point, and buttons to save alterations or to cancel. The user is then returned to “Customer's Profile.”

As shown in FIG. 32 the system is on server or computer. FIG. 32 illustrates a functional diagram of a computer network for World Wide Web 500 access to the System 1 from a plurality of Users 10 who accesses the System Web Site 100 or the Users 10 can connect directly to the System 1. Accessing the System Web Site 100 can be accomplished directly through a communication means such as a direct connection, an intranet, a local Internet Service Provider, often referred to as ISPs, or through an on-line service provider. Users 10 can be customers or businesses.

The users 10 contact the System Web Site 100 using an informational processing system (Client) capable of running an HTML compliant Web browser. A typical system that is used is a personal computer with an operating system running a Web browser. The exact hardware configuration of computer used by the users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one embodiment of the invention, the Users 10 connect to the System Web Site 100. In the preferred embodiment the system has numerous web pages. The information in the web pages are in HTML format via the HyperText Transport Protocol (http) and on Server System 310. The User System 110 includes software to allow viewing of web pages, commonly referred to as a Web Browser. The user system is capable of accessing web pages located on Server System 310.

Output can include a graphical user interface, hardcopy, facsimile, e-mail, messaging or other communication with any humanly or machine discernable data and/or artifacts. In some embodiments, output can include transmitting the risk variable related data to a designated recipient, any humanly or machine discernable data and/or artifacts.

### Conclusion

The model presented here is illustrated in demonstrative and not restrictive character, whose conception can vary how much the introduced tools, also being able of perfectioning or suffer some diversifications how much the techniques used in its functioning, without forget the inventive main target of the object whose protection is demanded.

For all the demonstrated aspects, the object deserves this patent and the protection as utility model.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) An improvement introduced in website's price and other market search system comprising: software electronically stored and run on a computer processor that makes possible the costumer's search about prices in several activities where said search system allows internet user to get all the product details, the suppliers, qualities, guarantees and prices for consumption ends in his region.

2) An improvement introduced in website's price and other market search system according to claim number 1, being the software (01) characterized by possess the following tool: Day Offers, that shows a costumer's region offers list, having a filter option for each activity (pharmacy, gas station, supermarket).

3) An improvement introduced in website's price and other market search system according to claim number 1, being the software (01) characterized by possess the following tool: Offers Warning, that send an e-mail to costumer with his region offers, defined in his profile, selected by activity (pharmacy, gas station, supermarket).

4) An improvement introduced in website's price and other market search system according to claim number 1, being the software (01) characterized by possess the following tool: Price Search, that allows costumer to search the prices in his region. These prices will be auto-update by the commercial establishment owners and guarantees a good synchronization. It's only necessary type the product name and it will be shown on a list with the best prices in his region.

5) An improvement introduced in website's price and other market search system according to claim number 1, being the software (01) characterized by possess the following tool: Product List and Shop List, that allows a products selection and a list develop by registered costumers where information will be sent by e-mail with best shop option indication in costumer's region.

6) An improvement introduced in website's price and other market search system according to claim number 1, being the software (01) characterized by possess the following tool: Prices Report, that makes a comparison between companies prices related to a region market with ranking of prices allowing the companies to control its prices.

7) An improvement introduced in website's price and other market search system according to claim number 1, being the software (01) characterized by possess the following tool: Price Way, that shows the best shop option in way predetermined by costumer. The way will be sent by e-mail to the costumer as the selected day, weekly or monthly.

8) An improvement introduced in website's price and other market search system according to claim number 1, where the software has the following tool, when the costumer types the product name the best price is exhibit instantaneously with information about the product's best price, considering the costumer's region.

9) An improvement introduced in website's price and other market search system according to claim number 1, where the software has the following tool, Product List, that allows the owners' search to know if there are any product that them don't sell, by list elaboration.

10) An improvement introduced in website's price and other market search system according to claim number 1, where the software has one of more of set of the following tools Products and Prices Auto-Update, that allows a prices and products auto-update by an interface between the search system and the company database, where this interface is provided by files transmission.

11) An improvement introduced in website's price and other market search system according to claim number 1, being the software (01) characterized by possess a tool that generates a ranking list by the best shop option.

12) An improvement introduced in website's price and other market search system according to claim number 1, where a customer connects to said system using the Internet.

13) An improvement introduced in website's price and other market search system comprising: software electronically stored and run on a computer processor that makes possible the costumer's search about prices in several activities where said search system allows internet user to get all the product details, the suppliers, qualities, guarantees and prices for consumption ends in his region, where said system has the following tools: Day Offers, that shows a costumer's region offers list, having a filter option for each activity (pharmacy, gas station, supermarket), Offers Warning, that send an e-mail to costumer with his region offers, defined in his profile, selected by activity (pharmacy, gas station, supermarket), Price Search, that allows costumer to search the prices in his region. These prices will be auto-update by the commercial establishment owners and guarantees a good synchronization. It's only necessary type the product name and it will be shown on a list with the best prices in his region, Product List and Shop List, that allows a products selection and a list develop by registered costumers where information will be sent by e-mail with best shop option indication in costumer's region, Prices Report, that makes a comparison between companies prices related to a region market with ranking of prices allowing the companies to control its prices, Price Way, that shows the best shop option in way predetermined by costumer. The way will be sent by e-mail to the costumer as the selected day, weekly or monthly, when the costumer types the product name the best price is exhibit instantaneously with information about the product's best price, considering the costumer's region, Product List, that allows the owners' search to know if there are any product that them don't sell, by list elaboration, Products and Prices Auto-Update, that allows a prices and products auto-update by an interface between the search system and the company database, where this interface is provided by files transmission.

14) An improvement introduced in website's price and other market search system according to claim number 1, being the software (01) characterized by possess a tool that generates a ranking list by the best shop option.

15) An improvement introduced in website's price and other market search system according to claim number 1, where a customer connects to said system using the Internet.
